(19) United States
(12) Patent Application Publication
(10) Pub. No.: US 2013/0089355 A1
(43) Pub. Date: Apr. 11, 2013

(54) CLEANING BLADE AND IMAGE FORMING APPARATUS

(71) Applicants: Satoshi NISHIDA, Saitama-shi (JP); Hideo YAMAKI, Tokyo (JP)

(72) Inventors: Satoshi NISHIDA, Saitama-shi (JP); Hideo YAMAKI, Tokyo (JP)

(73) Assignee: KONICA MINOLTA BUSINESS TECHNOLOGIES, INC., Tokyo (JP)

(21) Appl. No.: 13/611,145

(22) Filed: Sep. 12, 2012

(30) Foreign Application Priority Data
Oct. 5, 2011 (JP) 2011-221141

(51) Int. Cl. G03G 15/16

(52) U.S. Cl. 399/101

(57) ABSTRACT

A cleaning blade is described which hardly suffers from cut surface abrasion at the edge having a chamfered portion. A flat chamfered portion 60a is formed at the edge of the cleaning blade 60 where the chamfer angle thereof closer to the surface of an intermediate transfer belt 41 is set within a range of 20° to 65°. The chamfered portion 60a in a rubbing contact during printing is therefore prevented from being dragged in the moving direction ‘a’ of the surface of the intermediate transfer belt 41 to increase the rubbing contact width, and cut surface abrasion can be avoided.

### CROSS-REFERENCE TO RELATED APPLICATIONS

The present application claims priority under 35 U.S.C. §119 to Japanese Patent Application No. 2011-221141, filed Oct. 5, 2011. The contents of this application are herein incorporated by reference in their entirety.

### FIELD OF INVENTION

The present invention relates to a cleaning blade for use in an image forming apparatus such as a copying machine, a printer, a facsimile machine, or a multi-functional peripherals that combines the functions thereof, and an image forming apparatus equipped with this cleaning blade.

### DESCRIPTION OF RELATED ART

In such an image forming apparatus as described above, a cleaning blade is used for scraping excess toner and other attachments such as paper powder off the surface of an image bearing member from which a toner image has been transferred in a developing process. The image bearing member gets ready for forming the next toner image after removing attachments.

The cleaning blade is often made of a rubber so that the edge thereof does not damage the surface of the image bearing member, for example, as described in Japanese Patent Published Application No. 2006-220719, Japanese Patent Published Application No. Hei 6-332350 and Japanese Patent Published Application No. Hei 11-95631.

In a vicinity of the image bearing member, this cleaning blade is arranged with its edge oriented in a counter direction to the moving surface of the image bearing member so that the edge is in a rubbing contact with the image bearing member. The cleaning blade can thereby remove excess toner and other attachments which are adhered to the surface of the image bearing member as described above by scraping these attachments off the surface with the edge.

The cleaning capability of the cleaning blade depends on wear of the edge thereof, so that the edge is formed with a flat chamfered portion as described in Japanese Patent Published Application No. Hei 6-332350, Japanese Patent Published Application No. Hei 11-95631 or the like.

However, when the edge is formed with a chamfered portion, the chamfered portion is pulled in the moving direction of the surface of the image bearing member by frictional force between the chamfered portion and the surface of the image bearing member during cleaning, and thereby the rubbing contact width is often increased.

In such a case, the chamfered portion starts to wear from the portion which is slightly offset from the edge toward the cut surface (in the upstream direction of the rubbing contact). It is pointed out that, when this wear progresses as a defect and finally causes the edge to disappear, cleaning failure may be caused due to an increased wear width.

### SUMMARY OF THE INVENTION

To achieve at least one of the abovementioned objects, a cleaning blade which removes excess toner attached to a surface of an image bearing member, reflecting one aspect of the present invention, comprises an edge formed with a flat chamfered portion which is in a rubbing contact with the surface of the image bearing member, wherein the chamfer angle θ1 of the chamfered portion closer to the surface of the image bearing member is set as θ1=20° to 65°.

### BRIEF DESCRIPTION OF THE DRAWINGS

FIG. 1 is a view for schematically showing the overall configuration of an image forming apparatus in accordance with an embodiment of the present invention.

FIG. 2 is an explanatory expanded view for showing the belt cleaning unit of FIG. 1.

FIG. 3 is an explanatory view for showing the relationship between an intermediate transfer belt and a cleaning blade of the belt cleaning unit of FIG. 2 with an enlarged partial view.

FIG. 4A to FIG. 4C are explanatory views for showing edge wearing conditions corresponding to different chamfer angles of the cleaning blade.

### DETAILED DESCRIPTION OF THE PREFERRED EMBODIMENT

In what follows, an embodiment of the present invention will be described in detail with reference to drawings.

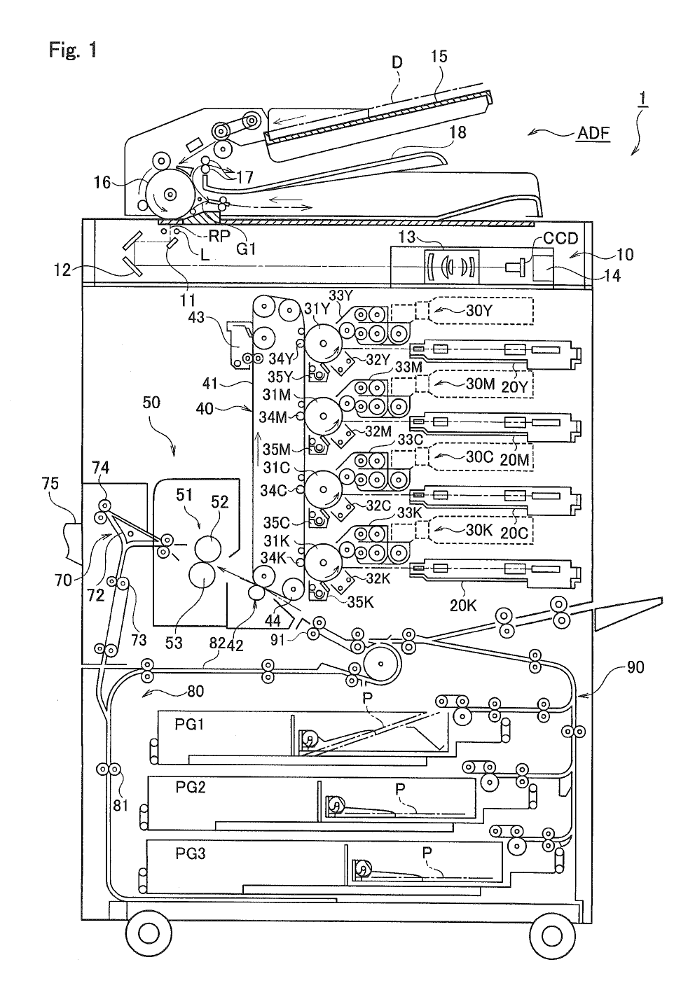

FIG. 1 shows the overall configuration of an image forming apparatus in accordance with the present invention.

This image forming apparatus 1 is a so-called tandem type color image forming apparatus capable of forming full-color images and including, as an image bearing member, a plurality of photoreceptor drums 31Y, 31M, 31C and 31K which are arranged in the vertical direction to face an intermediate transfer belt 41 serving as an image bearing member in a transfer device. In this case, from the view point of the photoreceptor drums 31Y, 31M, 31C and 31K the intermediate transfer belt 41 serves as an image receiving member.

The image forming apparatus 1 is provided with an automatic document feeder ADF installed on the top thereof. Original D is placed on an original placement tray 15 of the automatic document feeder ADF, and each sheet of the original D is separated from the other and supplied to an original conveying route where the sheet is conveyed by a conveyer drum 16.

An original reading unit 10 reads the image of the original D which is being conveyed in an original image reading position RP. After reading the original image, the original D is discharged to an original catch tray 18 by a first conveying guide G1 and an original discharge roller 17.

The image forming apparatus 1 is comprised of the original reading unit 10, exposure units 20Y, 20M, 20C and 20K, image forming units 30Y, 30M, 30C and 30K, a transfer device including an intermediate transfer unit 40 and a second transfer unit 42, a fixing unit 50, a discharge sheet reversing unit 70, a paper feed unit 90 and so forth, which are installed in one housing.

The original reading unit 10 exposes the image of each sheet of the original D to light from a lamp L in the original image reading position RP so that the light reflected from the image is led through a first mirror unit 11 and a second mirror unit 12 and focused through a lens unit 13 on the light receiving surface of an imaging device CCD. The imaging device CCD outputs image signals in a predetermined format by photoelectrically converting the light incident upon the imaging device CCD. The image reading control unit 14 processes the image signals by performing A/D conversion, shading compensation, data compression and so on, and outputs the processed image signals to a main control unit (not shown in the figure) in which the signals are stored in a storing unit. Namely, the image data stored in the storing unit has been properly processed as image output data in accordance with settings which are set up by a user.

The exposure units 20Y, 20M, 20C and 20K scan the surfaces of the photoreceptor drums 31Y, 31M, 31C and 31K, which are charged by main charging units 32Y, 32M, 32C and 32K respectively, while exposing these surfaces to laser beams in correspondence with the output information which is output from the control unit on the basis of the image output data. Electrostatic images are thereby formed on the photoreceptor drums 31Y, 31M, 31C and 31K respectively for yellow(Y), magenta(M), cyan(C) and black(BK).

The image forming unit 30Y includes the photoreceptor drum 31Y around which are located the main charging unit 32Y, a developing unit 33Y as a developing device, a first transfer roller 34Y and a cleaning unit 35Y. The other image forming units 30M, 30C and 30K have a similar structure as the image forming unit 30Y, and include the main charging units 32M, 32C and 32K, developing units 33M, 33C and 33K, first transfer rollers 34M, 34C and 34K and cleaning units 35M, 35C and 35K, which are located around the photoreceptor drums 31M, 31C and 31K respectively.

The developing unit 33Y, 33M, 33C and 33K make visible the latent images on the photoreceptor drums 31Y, 31M, 31C and 31K by developing the images with toners corresponding to yellow(Y), magenta(M), cyan(C) and black(BK) respectively. By this process, toner images are formed on the photoreceptor drums 31Y, 31M, 31C and 31K corresponding to yellow(Y), magenta(M), cyan(C) and black(BK) respectively.

The first transfer rollers 34Y, 34M, 34C and 34K transfer the toner images, which are formed on the photoreceptor drums 31Y, 31M, 31C and 31K, to the intermediate transfer unit 40 as an intermediate transfer member, more specifically speaking, to a predetermined location of the intermediate transfer belt 41 in order that the toner images overlap each other. A color image is formed on the intermediate transfer belt 41 by overlapping the toner images of the different colors. The intermediate transfer belt 41 is an endless belt which rotates and travels by the driving force of a belt drive roller 44 in the direction indicated by an arrow in FIG. 1.

The cleaning units 35Y, 35M, 35C and 35K clean the surfaces of the photoreceptor drums 31Y, 31M, 31C and 31K by removing toner which remains on the surfaces of the photoreceptor drums 31Y, 31M, 31C and 31K after transferring the toner to the intermediate transfer belt 41. The photoreceptor drums 31Y, 31M, 31C and 31K is ready for forming the next toner image by the cleaning process.

On the other hand, the second transfer unit 42 transfers the color image, which is formed on the intermediate transfer belt 41 by overlapping the different color images, to a sheet P which is conveyed from trays PG1, PG2 and PG3 of the paper feed unit 90 and supplied as an image receiving member or a recording medium by a resist roller 91 with an appropriate timing. The belt cleaning unit 43 cleans the surface of the intermediate transfer belt 41 by removing toner which remains on the surface of the intermediate transfer belt 41 after finishing transferring the color image to the sheet P. The intermediate transfer belt 41, which is cleaned, gets ready for transferring the next image.

The sheet P bearing the toner image is conveyed to the fixing unit 50 which presses and heats the sheet P to fix the toner image to the sheet P. In the case of the example shown in FIG. 1, the fixing unit 50 includes the fixing device 51 comprising a heat roller 52 and a pressure roller 53 serving as nip rollers in combination.

The discharge sheet reversing unit 70 conveys the sheet P from the fixing unit 50 after a fixing process, and discharges the sheet P to the catch tray 75. When the sheet P is to be discharged after reversing the front and back sides, the discharging guide 72 first directs the sheet P downward, holds the sheet P between discharge sheet reversing rollers 73, and then conveys the sheet P backward to a discharging roller 74 from which the reversed sheet P is discharged.

When an image is to be formed also on the back side of the sheet P, the discharging guide 72 conveys the sheet P to a paper refeed unit 80 located below after fixing a toner image on the main side of the sheet P, holds the sheet P between sheet reversing refeed rollers 81 followed by conveying the sheet P backward to reverse the sheet P, directs the sheet P to a refeed conveying route 82 to start image formation on the back side.

A cleaning blade 60 made of an elastic material such as an urethane rubber is used in the cleaning units 35Y, 35M, 35C and 35K of the image forming units 30Y, 30M, 30C and 30K and the belt cleaning unit 43 of the intermediate transfer belt 40.

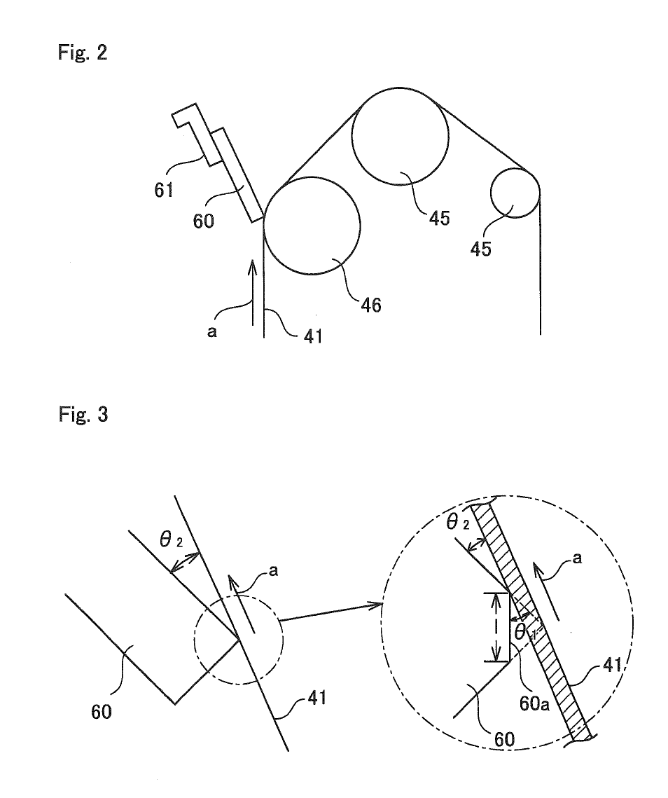

FIG. 2 shows the belt cleaning unit 43 of the intermediate transfer unit 40. The cleaning blade 60 is mounted on a support member 61. In a vicinity of the intermediate transfer belt 41, the cleaning blade 60 is arranged with its edge oriented in a counter direction to the moving direction of the surface of the intermediate transfer belt 41 so that the edge is in a rubbing contact with the surface of the intermediate transfer belt 41.

In the case of the example as shown in the figure, the cleaning blade 60 is arranged adjacent to belt guide rollers 45 which are upper rollers of belt guide rollers around which the intermediate transfer belt 41 extends. Also, the edge which is in a rubbing contact with the surface of the intermediate transfer belt 41 is received by a blade counter roller 46 with the intermediate transfer belt 41 therebetween.

The edge of the cleaning blade 60 is formed with a flat chamfered portion 60a as shown in FIG. 3.

The chamfered portion 60a is formed so that a chamfer angle θ1 is within a range of 20° to 65° on the basis of experimental results shown in Table 1, where the chamfer angle θ1 is one of the chamfer angles which is located closer to the surface of the intermediate transfer belt 41 when the edge comes in a rubbing contact with this belt.

Taking cleaning performance into consideration, the chamfered portion 60a is formed to have a very small width of 1 to 20 μm (denoted by “l” in FIG. 3). This chamfered portion 60a may be formed by a grinding process, i.e., rubbing the portion to be chamfered against a rotating cylinder made from a metal such as aluminum while calcium titanate is supplied as an abrasive. Alternatively, this chamfered portion 60a may be shaped by injection moulding the cleaning blade 60.

On the other hand, a contact tilt angle of the cleaning blade 60 relative to the intermediate transfer belt 41, i.e., the angle θ2 between the surface of the intermediate transfer belt 41 and the main surface of the cleaning blade 60 adjacent to the edge is set to 10° to 20°. The main surface refers to one of the surfaces of the polygonal cleaning blade 60 having the largest area. This contact tilt angle θ2 of the cleaning blade 60 within a range of 10° to 20° is empirically known as an effective contact angle at which the edge is not ripped off by the friction with the intermediate transfer belt 41 and that cleaning failure does not occur.

In relation to the effective contact angle (θ2=10° to 20°) of the cleaning blade 60, the chamfer angle θ1 is set in order that θ1-θ2=0° to 55°.

Table 1 shows wear conditions as results of experiments conducted by performing printing operations for 100 consecutive hours while changing the chamfer angle θ1 of the chamfered portion 60a of the cleaning blade 60 within a range of 15° to 70°, and the contact tilt angle θ2 of the cleaning blade 60 within a range of 5° to 25°.

TABLE 1

| θ1 | θ2 | θ1 − θ2 | Cut Surface Abrasion |
|---|---|---|---|
| 15 | 5 | 10 | X (partial abrasion) |
| 15 | 15 | 0 | X (partial abrasion) |
| 15 | 10 | 5 | X (partial abrasion) |
| 18 | 15 | 3 | X (partial abrasion) |
| 20 | 10 | 10 | Δ (suspicious but acceptable) |
| 30 | 15 | 15 | ◯ (no abrasion) |
| 40 | 10 | 30 | ◯ (no abrasion) |
| 45 | 13 | 32 | ◯ (no abrasion) |
| 35 | 13 | 22 | ◯ (no abrasion) |
| 55 | 13 | 42 | ◯ (no abrasion) |
| 58 | 20 | 38 | ◯ (no abrasion) |
| 60 | 10 | 50 | ◯ (no abrasion) |
| 60 | 13 | 47 | ◯ (no abrasion) |
| 60 | 15 | 45 | ◯ (no abrasion) |
| 65 | 13 | 52 | Δ (suspicious but acceptable) |
| 65 | 10 | 55 | Δ (suspicious but acceptable) |
| 68 | 11 | 57 | X (partial abrasion) |
| 70 | 5 | 65 | X (partial abrasion) |
| 70 | 15 | 55 | X (partial abrasion) |
| 70 | 25 | 45 | X (partial abrasion) |

From the experimental results of Table 1, it was conformed that no cut surface abrasion was observed on the chamfered portion 60a within a range of 20° to 65° when the cleaning blade 60 was set at any effective contact angle selected within a range of 10° to 20° and that the chamfered portion 60a worn in a normal way.

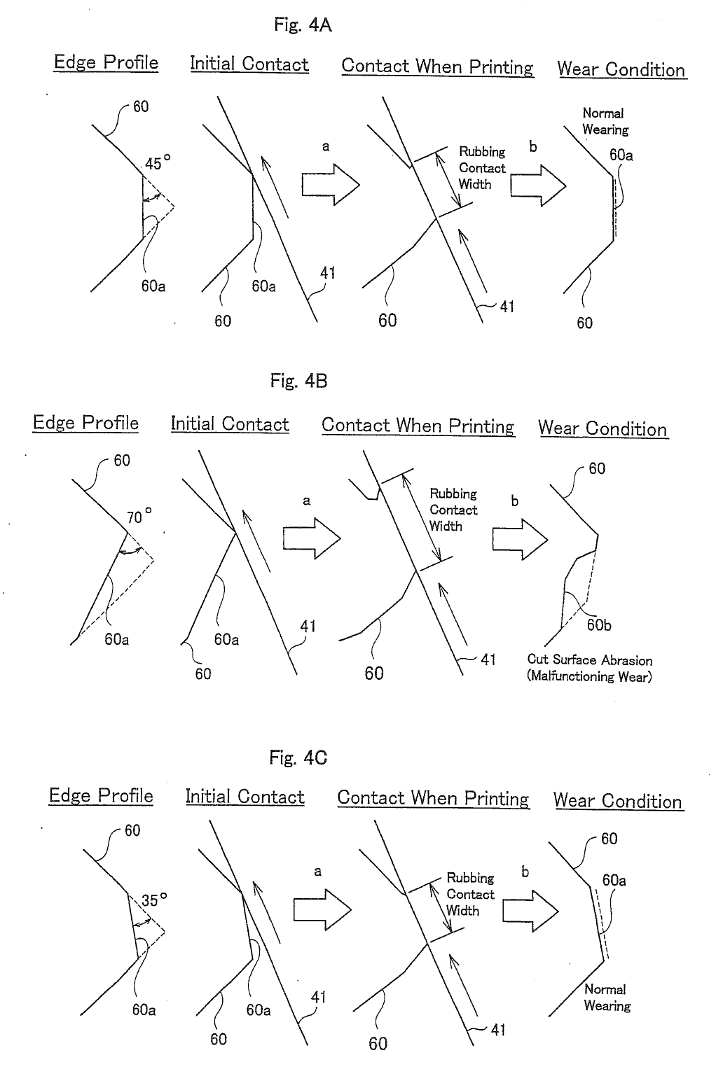

Namely, if the chamfer angle θ1 is set within a range of 30° to 60° and if the contact tilt angle θ2 is set to an effective contact angle (θ2=10° to 20°) as shown in FIGS. 4A and 4C, the chamfered portion 60a wears in a normal way rather than wearing from the portion which is slightly offset from the edge toward the cut surface in the upstream direction of the rubbing contact, as the cut surface abrasion.

FIG. 4A shows the scenario when the chamfer angle θ1 is set as θ1=45°. At this chamfer angle θ1, the chamfered portion 60a is not dragged by frictional force between the chamfered portion 60a and the intermediate transfer belt 41 even when the edge is first in an initial contact with the intermediate transfer belt 41 and then comes in a rubbing contact during printing as shown with arrow ‘a’. The rubbing contact width of the edge is not increased beyond the initial width of the chamfered portion 60a. By this condition, the chamfered portion 60a uniformly wears as shown with arrow ‘b’.

FIG. 4C shows the scenario when the chamfer angle θ1 is set as θ1=35°. Also, at this chamfer angle θ1, the chamfered portion 60a is not dragged even when the contact of the edge is switched from an initial contact to a rubbing contact during printing as shown with arrow ‘a’. The rubbing contact width of the edge is therefore not increased beyond the initial width of the chamfered portion 60a. By this condition, the chamfered portion 60a uniformly wears as shown with arrow ‘b’ in a normal way.

In this case, if the chamfer angle is set as θ1=20°, no cut surface abrasion occurs in the chamfered portion 60a when the cleaning blade 60 is set at the maximum effective contact angle, i.e., θ2=20° (θ1-θ2=0°), in the same manner as has been discussed above. When the cleaning blade 60 is set at an effective contact angle θ2 of 10°, the chamfered portion 60a tends to be dragged, but no cut surface abrasion occurs also in this case so that this tendency is an acceptable level.

If the chamfer angle is set as θ1=65°, the chamfered portion 60a tends to be dragged when the cleaning blade 60 is set at the minimum effective contact angle, i.e., θ2=10° or at an angle thereabout, e.g., θ2=13°. However, it was confirmed that no cut surface abrasion occurs also in this case so that the dragging condition is an acceptable level.

On the other hand, it was confirmed that, when the chamfer angle θ1 is larger than 65°, e.g., θ1=68°, θ1=70°, cut surface abrasion 60b occurs in the chamfered portion 60a so that the chamfered portion 60a wears in an irregular manner as shown in FIG. 4B.

FIG. 4B shows the scenario when the chamfer angle θ1 is set as θ1=70°. In this case, even if the contact tilt angle θ2 is set to an effective contact angle θ2 within a range of 10° to 20° or set to an angle outside this range, the chamfered portion 60a is dragged as shown with arrow ‘a’ when the contact of the edge is switched from an initial contact to a rubbing contact during printing. The rubbing contact width of the edge is therefore increased beyond the initial width of the chamfered portion 60a. Because of this, cut surface abrasion 60b occurs in the chamfered portion 60a as shown with arrow ‘b’ to increase the frictional force which recursively accelerates the cut surface abrasion 60b. When the edge finally disappears by this process, the wear width rapidly increases to cause cleaning failure.

On the other hand, it was confirmed that, when the chamfer angle θ1 is smaller than 20°, e.g., θ1=18°, θ1=15°, the chamfered portion 60a is dragged during printing even if the contact tilt angle θ2 is set to an effective contact angle θ2 within a range of 10° to 20° or set to an angle outside this range, and cut surface abrasion 60b occurs in the chamfered portion 60a in the same manner as shown in FIG. 4B.

From the fact described above, the chamfer angle θ1 of the chamfered portion 60a is set as θ=20° to 65°. Furthermore, when the contact tilt angle θ2 is set to an effective contact angle θ2 within a range of 10° to 20°, it will be understood how effective the chamfer angle θ1 and this angle θ2 are adjusted to satisfy θ1-θ2=0° to 55° for having the chamfered portion 60a wear in a normal way.

As has been discussed above, in accordance with the cleaning blade and the image forming apparatus of the present embodiment, the edge of the chamfered portion 60a is formed with the chamfered portion 60a at the chamfer angle θ1, which is one of the chamfer angles closer to the surface of the intermediate transfer belt 41, within an optimum range of 20° to 65° on the basis of experimental results. By this configuration, the chamfered portion 60a in a rubbing contact during printing is prevented from being dragged in the moving direction of the surface of the intermediate transfer belt 41 to increase the rubbing contact width.

It is therefore possible to avoid cut surface abrasion that the chamfered portion 60a wears from the portion which is slightly offset from the edge toward the cut surface. This increases the durability of the cleaning blade 60 and improves the cleaning capability.

Also, when the contact tilt angle θ2 of the cleaning blade 60 is set to an effective contact angle θ 2 within a range of 10° to 20°, the chamfer angle θ and this angle θ2 are adjusted to satisfy θ1-θ2=0° to 55°. This makes it possible to effectively avoid cut surface abrasion from occurring in the chamfered portion 60a, and further improve the durability of the cleaning blade 60 and the cleaning capability.

Furthermore, the cleaning blade 60 is a rubber blade which is advantageous to alleviate the damage to the surface of the intermediate transfer belt 41. In this case, the chamfered portion 60a can be formed by an usual process, e.g., grinding the edge, or injection moulding the cleaning blade 60 with a shaping die designed to form the edge, and thereby there is an advantage in terms of costs.

Although the present invention has been described as an example with the cleaning blade 60 in the cleaning unit 43 of the intermediate transfer unit 40 of the image forming apparatus 1, needless to say, it is also applicable to the cleaning blade used in the cleaning units 35Y, 35M, 35C and 35K of the image forming units 30Y, 30M, 30C and 30K. In this case, each of the photoreceptor drums 31Y, 31M, 31C and 31K serve as an image bearing member. Then, from the view point of the photoreceptor drums 31Y, 31M, 31C and 31K the intermediate transfer belt 41 serves as an image receiving member.

The foregoing description has been presented on the basis of the embodiments. However, it is not intended to limit the present invention to the precise form described, and obviously many modifications and variations are possible within the scope of the invention.

1. A cleaning blade which removes excess toner attached to a surface of an image bearing member, comprising:
an edge formed with a flat chamfered portion which is in a rubbing contact with the surface of the image bearing member,
wherein the chamfer angle θ1 of the chamfered portion closer to the surface of the image bearing member is set as θ1=20° to 65°.

2. The cleaning blade of claim 1 wherein, when an angle θ2 between the surface of the image bearing member and a main surface of the cleaning blade is set to an effective contact angle θ2 such that θ2=10° to 20°, the chamfer angle θ1 and the angle θ2 are set in order that θ1-θ2=0° to 55°.

3. The cleaning blade of claim 1 wherein the chamfer angle θ1 of the chamfered portion closer to the surface of the image bearing member is set as θ1=30° to 60°.

4. The cleaning blade of claim 1 wherein the cleaning blade is a rubber blade.

5. The cleaning blade of claim 1 wherein the edge of the cleaning blade is formed by grinding the chamfered portion.

6. The cleaning blade of claim 1 wherein the edge of the cleaning blade is formed by injection moulding the cleaning blade with a shaping die designed to form the edge.

7. The cleaning blade of claim 1 wherein the image bearing member is an intermediate transfer member.

8. An image forming apparatus comprising:
an image forming unit configured to form a toner image on an image bearing member;
a transfer unit configured to transfer the toner image formed on the image bearing member to an image receiving member; and
a cleaning blade configured to remove excess toner remaining on the surface of the image bearing member after transferring the image,
wherein the cleaning blade is provided with a flat chamfered portion at the edge of the cleaning blade which is in a rubbing contact with the surface of the image bearing member, and
wherein the chamfer angle θ1 of the chamfered portion closer to the surface of the image bearing member is set as θ1=20° to 65°.
